(19) United States
(12) Patent Application Publication
(10) Pub. No.: US 2026/0136178 A1
(43) Pub. Date: May 14, 2026

(54) NETWORK SLICE AUTHENTICATION

(71) Applicant: T-MOBILE INNOVATIONS LLC, Overland Park, KS (US)

(72) Inventor: Roopesh Kumar POLAGANGA, Bothell, WA (US)

(21) Appl. No.: 18/943,550

(22) Filed: Nov. 11, 2024

(51) Int. Cl. H04W 12/06

(52) U.S. Cl. CPC H04W 12/06

(57) ABSTRACT

Embodiments of the present disclosure are directed to systems, networks and methods for determining, using a network function of an operator core network for a telecommunications network, an occurrence of a slice transaction associated with a network slice having a set of slice data, determining that the slice transaction is a valid slice transaction through the utilization of a consensus mechanism of a blockchain ledger. Aspects may also cause the storage of the set of slice data in a block of the blockchain ledger, orchestrating the slice transaction on the operator core network, based on causing the storage of the set of slice data in the block of the blockchain ledger; and selectively allocating the network slice to one or more user equipment (UE) in communication with the at least one radio access network.

### BACKGROUND

A 5G network slice is a telecommunications network configuration that establishes multiple independent virtualized networks on the common physical infrastructure of a 5G network operator core. For each network slice instance, associated network functions can be orchestrated as needed to support the specific needs and/or use case of the customer using the network slice. Network resources allocated to a network slice may be tailored to customize parameters such as bandwidth, speed, and latency. A network slice may be established for a customer by the 5G network operator as a service that essentially provides the customer with a private end-to-end networking solution that includes complete logical isolation from other slices operating on the same physical infrastructure elements of the 5G network operator core and through common access networks (e.g., radio access networks).

### SUMMARY

The present disclosure is directed to systems and methods for network slice authenticity management.

Telecommunication networks have the ability to generate distinct network slices which may be configured with various parameters such as increased bandwidth, low latency, or any other telecommunication parameter to meet the needs of users. As these network slices become easier to generate and more dynamic in nature, the authenticity of network slices need to be ensured. As such, aspects of the described technology utilize blockchain ledger technologies to store and validate slice transactions such as the generation, activation and/or deactivation of network slices whether dynamic or static. When a network slice is generated, slice data may be validated through the utilization of a blockchain ledger and stored in a block of a blockchain. The slice data may comprise a slice identifier, authorized user identifier, time identifier, geographic identifier, or slice parameters and may be stored in association with the slice identifier in a block of the blockchain. In embodiments, the slice parameters may include the bandwidth, latency, the capacity of users available, security parameters, or any number of parameters that identify the unique nature of the slice. This data may be stored in a block of the blockchain ledger such that the slice transaction is immutable and may be reviewed at a future time for authenticity. In additional or alternative embodiments, the blockchain ledger may authenticate the slice data prior to adding the slice data to the blockchain. In embodiments wherein the authentication fails, the generation or activation of the slice may be refused and data associated with the refusal of the generation or activation may be stored on the blockchain.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment for a telecommunications network, in accordance with some embodiments described herein;

FIG. 2 is a diagram illustrating an example operator core network for a telecommunications network implementing a network slice blockchain integrity service, in accordance with some embodiments described herein;

FIG. 3 is a diagram illustrating an example network slice blockchain integrity service, in accordance with some embodiments described herein;

FIG. 4 is a diagram illustrating an example database comprising slice data for a network slice blockchain integrity service, in accordance with some embodiments described herein;

FIG. 5 is a flow chart illustrating an example method for a network slice blockchain integrity service, in accordance with some embodiments described herein;

FIG. 6 is an example computing device, in accordance with some embodiments described herein; and

FIG. 7 is an example cloud computing platform, in accordance with some embodiments described herein.

### DETAILED DESCRIPTION

The subject matter of embodiments are described herein with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE (User Equipment) and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions - including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Telecommunication networks have the ability to generate distinct network slices which may be configured with various parameters such as increased bandwidth, low latency, and/or other telecommunication parameters to meet the needs of users. As these network slices become easier to generate and more dynamic in nature, the integrity and/or authenticity of network slices need to be ensured. As such, aspects of the described technology utilize blockchain technologies to store and validate the generation, activation and/or deactivation of network slices whether dynamic or static. When a network slice is generated, slice data may be validated through the utilization of a blockchain ledger and stored in a block of a blockchain. The slice data may comprise a slice identifier, authorized user identifier, time identifier, geographic identifier, or slice parameters and may be stored in association with the slice identifier in a block of the block chain. In embodiments, the slice parameters may include the bandwidth, latency, the capacity of users available, security parameters, and/or any number of parameters that identify the particular nature of the slice. This data may be stored in the blockchain such that the slice transaction is immutable and may be reviewed at a future time for authenticity. In additional or alternative embodiments, the blockchain ledger may authenticate the slice data prior to adding the slice data to the blockchain. In embodiments wherein the authentication fails, the generation or activation of the slice may be refused and data associated with the refusal of the generation or activation may be stored on the block chain.

A 5G network slice is a telecommunications network configuration that establishes multiple independent virtualized networks on the common physical infrastructure of a 5G network operator core. For each network slice instance, associated network functions can be orchestrated as needed to support the specific needs and/or use case of the customer using the network slice. Network resources allocated to a network slice may be tailored to customize parameters such as bandwidth, speed, and latency. A network slice may be established for a customer by the 5G network operator as a service that essentially provides the customer with a private end-to-end networking solution that includes complete logical isolation from other slices operating on the same physical infrastructure elements of the 5G network operator core and through common access networks (e.g., radio access networks).

By way of background, telecommunication networks may utilize network slicing to allow multiple virtual networks to be created on a shared physical infrastructure. Each slice may be customized to meet the specific needs of various application and services and network slices are generally created as static elements which may be activated or deactivated as needed. When these slices are generated, they are generally generated by authorized personnel with proper credentials of a telecommunication service. Additionally, these slices may be available to all consumers through a subscription service, may be available to only certain industries with specific requirements (such as smart vehicles requiring incredibly low latency services) or may be available to all users of the telecommunication service. But, the rise of network slicing brings new safety and security concerns which need be addressed. Conventionally, these network slices are static and created without an assurance as to the credentials of those who create it. But, network slices may be static or may be dynamically created. For example, a telecommunication network may have a set number of slices for any given timeframe which have their own properties to facilitate any number of specialized or generalized services.

A telecommunication network may additionally or alternatively utilize dynamic network slicing which allows for the generation of specialized network slices based on any number of factors. For example, it may be determined that a football game will be taking place at a particular stadium. That stadium may normally be unoccupied or at least have a relatively low number of telecommunication users located at its geographic region. But when a major game, such as a college football game, is scheduled at that arena the number of individuals located at that geographic region may spike. In this situation, it may be beneficial to generate a new dynamic slice, or a set of new dynamic slices of a 5G network to facilitate the increased number of individuals, or to provide for specific services at this location. A dynamic slice may be generated based on any number of factors, and may be generated with any number of network customizations. For example, a news reporting slice may be dynamically generated at in association with the above referenced sporting event. This news reporting slice may be customized with a lower latency and a high bandwidth. This would allow for users who have the authorization to utilize that slice to broadcast news or highlights at a higher speed. A dynamic premium slice with limited available spots and low latency and high reliability may additionally or alternatively be generated. Users associated with a telecommunication network may be notified of the generation of this premium slice.

However, ensuring the integrity and authenticity of these dynamic slices as well as current static slices poses unique challenges. Users with access to static or dynamic slices need to be authenticated so that only authorized users or users that have properly subscribed to the services of a certain slice are allowed to use the slice. Additionally, users with authority to generate or activate dynamic or static slices along with the parameters of the generated or activated slices need to be authenticated to ensure proper utilization of limited network resources. So, as dynamic slices become more broadly used, slices will be generated, activated, and deactivated on a larger scale. These generations and activations will pose new security risks which must be addressed to ensure that unauthorized parties or bad actors do not generate, activate, or gain access to slices they should not. If the security risks are not addressed, bad actors may be able to generate network slices by utilizing stolen or faked credentials, or at incorrect times or incorrect geographic locations. This could allow for any individual to create slices on a telecommunication 5G network creating latency, reliability, and security issues. As such, current methods for maintaining slice authenticity are insufficient to prevent unauthorized access, generation, activation, and tampering for these static and dynamic network slices.

Unlike conventional solutions, some aspects of the described technology address these challenges by leveraging blockchain and distributed ledger technology to provide a robust solution for verifying and maintaining slice authenticity. Namely, the described technology utilizes blockchain and distributed ledger technology to ensure the integrity and authenticity of network slices in telecommunication networks by employing a distributed ledger, such as a blockchain ledger, to record slice transactions related to the generation, activation, and deactivation of network slices.

The blockchain network may be implemented across multiple nodes in a centralized or decentralized manner, and may be stored in association with a telecommunication network or may be a distinct computer hardware. This provides a tamper-proof mechanism for verifying slice parameters and authenticity and ensuring that network slices remain consistent and secure. A block of the block chain may be generated at any stage of the lifetime of a slice, for example, at the creation of the original parameters for the slice, at any subsequent activations of the slice, at the deactivation of the slice, or at the deletion of the slice. In embodiments, a block is only added to the blockchain when the information used to authenticate the creation or the activation of the slice matches the information stored on a blockchain ledger.

Additionally or alternatively, a set of base slice data may be set at a local node of a blockchain ledger network. This set of base slice data may be used to determine the authenticity of any slice that is attempted to be generated or activated. This set of base slice data may comprise any number of parameters which indicate the authenticity of a slice. For example, these may include a set of authorized user identifiers, or a set of allowable geographic locations. These may comprise slice parameters that are allowable such as a range of bandwidth or latency which may be set when generating or activating a slice. In embodiments, if a slice is generated with incorrect base slice data or with slice parameters that fall outside of the acceptable range of base slice data, then the transaction related to the activation or generation of the slice may be flagged within the blockchain. This set of base slice data and base slice parameters may be determined based on an analysis of available resources at the time of generation or activation of the slice, or they may be predetermined by a user. In embodiments, a set of base slice data is not required, instead, a block chain may have an initial transaction which is valid through any means, and that original transaction on the blockchain may be used as the base slice data and slice parameters for that blockchain and utilized by the blockchain ledger to validate, invalidate, or flag future blocks related to future transactions.

When a slice is generated or activated, the transaction and parameters related to the transaction may be stored in a block of a blockchain, or may be validated by a blockchain ledger prior to being stored as a block in a blockchain. This allows for the information in the blockchain to be utilized in reviewing a history of transactions related to the slice and in the validation of a slice as it is generated or activated. For example, an authorized user may generate a slice for the geographic region associated with a sporting event taking place at a future time at a specific geographic region. The original generation of this slice may include slice data such as a slice identifier, authorized user identifier, time identifier, geographic identifier, or slice parameters and may be stored in association with the slice identifier in a block of the block chain. In embodiments, the slice parameters may include the bandwidth, latency, the capacity of users available, security parameters, or any number of parameters that identify the unique nature of the slice.

At the time of generation of this slice, a blockchain ledger may be utilized to validate the generation of the slice. For example, if the authorized user identifier is not recognized, the data associated with the generation of this slice may not be validated by the blockchain ledger. In embodiments, this may result in the failure of the generation of that slice, or may result in storing the unauthorized generation or activation in the block chain. If the validation is a failure and the slice is not generated, the failed transaction may additionally or alternatively be stored on the blockchain to create a history of transactions associated with a failed slice creation. In embodiments, the slice data may be stored without validating the information, but through the storage in a block of a block chain, the data is securely stored. At a future time this securely stored slice data may be utilized to determine the authenticity of the slice by a separate process. Each of these embodiments may be utilized to determine areas or parameters that are associated with unauthorized users or unauthorized generation of network slices. In embodiments in which the slice is generated, but flagged as unauthorized, the flagged unauthorized parameters may be utilized to terminate the slices or deny future activations of the slice. As such, aspects of the present technology generate an immutable history of transactions related to network slices such as generation, activation, or deactivation which may be utilized in the review and deactivation or flagging of unauthorized slices. Additionally or alternatively, aspects of the present technology utilize a blockchain ledger to validate transactions related to network slices prior to authorizing the transactions and allowing for the transactions to take place.

The blockchain ledger and block chain technologies may be used when authorizing users to gain access to dynamic or static slices. In embodiments, smart contracts may be utilized to validate transactions when a user attempts to gain access to a slice. If the user does not have the correct identifiers, then the user may be denied access to the slice. The data associated with authorized users may be included in the block related to the generation of the slice, activation of the slice, or additional blocks may be generated when a new user is authorized so that the user identifier may be validated when they attempt to gain access.

Accordingly, aspects of the present disclosure discuss systems, networks and methods for determining, using a network function of an operator core network for a telecommunications network, an occurrence of a slice transaction associated with a network slice having a set of slice data, determining that the slice transaction is a valid slice transaction through the utilization of a consensus mechanism of a blockchain ledger. Aspects may also cause the storage of the set of slice data in a block of the blockchain ledger, orchestrating the slice transaction on the operator core network, based on causing the storage of the set of slice data in the block of the blockchain ledger; and selectively allocating the network slice to one or more user equipment (UE) in communication with the at least one radio access network.

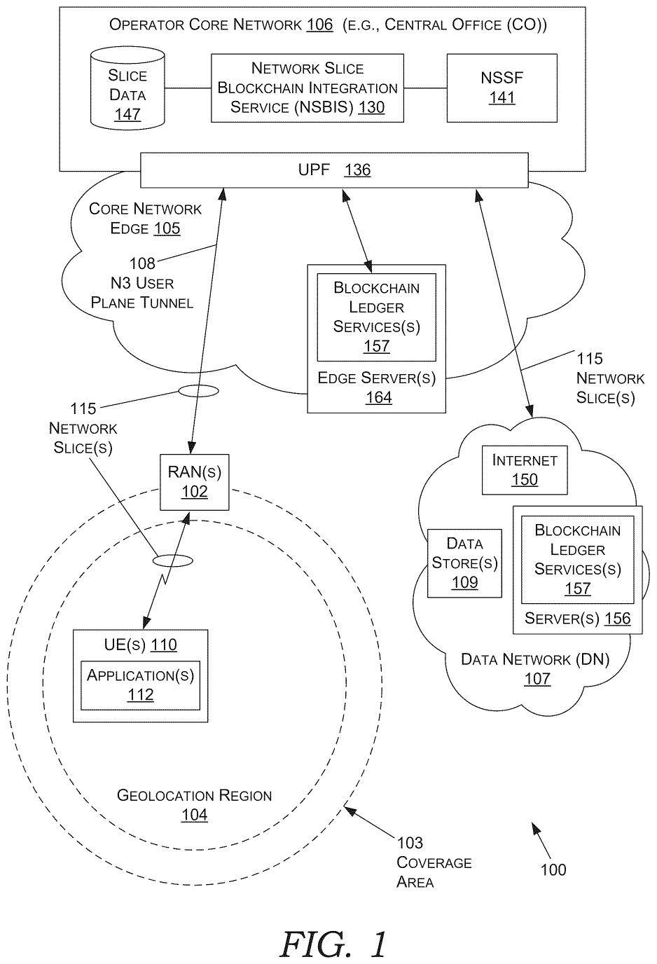

As shown in FIG. 1, network environment 100 comprises an operator core network 106 (also referred to as a “core network”) that provides one or more network services to one or more UEs 110 (e.g., 3GPP UE) via at least one access network, such as radio access network (RAN) 102. In some embodiments, network environment 100 comprises, at least in part, a wireless communications network, such as, but not limited to, a 5G wireless communications network.

In some embodiments, the network environment 100 comprises one or more radio access networks (RANs) 102, which may be referred to in the context of a wireless telecommunications network as a wireless base station, cell site, or cellular base station. A RAN 102 may represent at least one wireless base station coupled to an operator core network to establish one or more communication links between the operator core network 106 and a user equipment (UE) 110. Each RAN 102 may provide wireless connectivity access to one or more UEs (such as UE 110) operating within a coverage area 103 associated with that RAN 102. The RAN 102 may implement wireless connectivity using, for example, 3GPP technologies. The RAN 102 may be referred to as an eNodeB in the context of a 4G Long-Term Evolution (LTE) implementation, a gNodeB in the context of a 5G New Radio (NR) implementation, or other terminology depending on the specific implementation technology. In some embodiments, the RAN 102 may comprise, at least in part, components of a customer premises network, such as a distributed antenna system (DAS), for example. In the embodiments described herein, the one or more RANs 102 may establish a coverage area 103 that covers a geolocation region 104. For example, the geolocation region 104 may correspond to a stadium, conference center, park, or other venue or facility where an event is scheduled to take place. From within the geolocation region 104, any number of dynamic slices may be generated and the slice data associated with each of these slices may be stored in a blockchain ledger such as the blockchain ledger service 157 through the utilization of the network slice blockchain integrity service (NSBIS) 130.

Radio access network(s) 102 may comprise a multimodal network (for example, comprising one or more multimodal access devices) where multiple radios supporting different systems are integrated into the radio access network(s) 102. Such a multimodal access network may support a combination of 3GPP radio technologies (e.g., 4G, 5G, and/or 6G) and/or non-3GPP radio technologies (e.g., IEEE 802.11 (WiFi) and/or IEEE 802.15 (Bluetooth) access points). In some embodiments, the radio access network(s) 102 may comprise a terrestrial wireless communications base station and/or may be at least in part implemented as a space-based access network, such as a base station implemented by an Earth-orbiting satellite. Individual UE 110 may communicate with the operator core network 106 via the RAN 102 over one or both of uplink (UL) radio frequency (RF) signals and downlink (DL) radio frequency (RF) signals.

The radio access network(s) 102 may be coupled to the operator core network 106 via a core network edge 105 that comprises edge server network nodes and wired and/or wireless network connections that may further include wireless relays and/or repeaters. In some embodiments, the RAN 102 may be coupled to the operator core network 106 at least in part by a backhaul network such as the Internet or other public or private network infrastructure. Core network edge 105 may comprise one or more network nodes (e.g., servers) and/or other elements of the operator core network 106 that may define the boundary of the operator core network 106 and may serve as the architectural demarcation point where the operator core network 106 connects to other networks such as, but not limited to, RAN 102, the Internet 150, Data Network (DN) 107, and/or other third-party networks. In some embodiments, the core network edge 105 may comprise one or more network nodes that include one or more edge servers 164. Edge server(s) 164 may provide, for example, edge-based services separate from services provided by network functions of the operator core network 106. For example, edge server(s) 164 may host databases, caches, microservices, ledgers, decentralized applications (e.g., DApps), and/or may perform data traffic monitoring, inspections, and/or aggregation for other network functions of the network environment 100. In some embodiments, one or more edge servers 164 may host one or more of the blockchain ledger services 157 described herein.

It should be understood that in some aspects, the network environment 100 may not comprise a distinct operator core network 106, but rather may implement one or more features of the operator core network 106 within other portions of the network, or may not implement them at all, depending on various carrier preferences.

As shown in FIG. 1, network environment 100 may also comprise at least one data network (DN) 107 coupled to the operator core network 106 (e.g., via the core network edge 105). In some embodiments, DN 107 may at least in part comprise the Internet 150. Data network 107 may include one or more data stores 109 and/or one or more servers 156 that host server applications such as one or more of the blockchain ledger services 157. In some embodiments, UE 110 may access services and/or content provided by the data store(s) 109 and/or server(s) 156 of DN 107.

Generally, an individual UE 110 may comprise a device capable of unidirectional or bidirectional communication with the operator core network 106 via wireless and/or wired communication links. The network environment 100 may be configured for wirelessly connecting UEs 110 to other UEs 110 via the same access networks (e.g., RANs 102), via other access networks, via other telecommunication networks, and/or to connect UEs 110 to a public switched telecommunication network (PSTN). The network environment 100 may be generally configured, in some embodiments, for connecting UE 110 to data, content, and/or services that may be accessible from one or more application servers or other functions, nodes, or servers.

In allocating network resources and access to these data or services, the operator core network 106 may instantiate one or more network slices 115 and allocate one or more of those network slice(s) 115 to carry network traffic for one or more applications 112 executed by processors of the UE 110. Within the context of the network slice(s) 115 as described herein, an individual UE 110 may function in the capacity of a subject entity that requests data and/or services from other networked elements (e.g., network functions and/or elements of DN 107) via network slice(s) 115 and/or a resource entity that provides data and/or services to other networked elements (e.g., network functions and/or elements of DN 107) via network slice(s) 115.

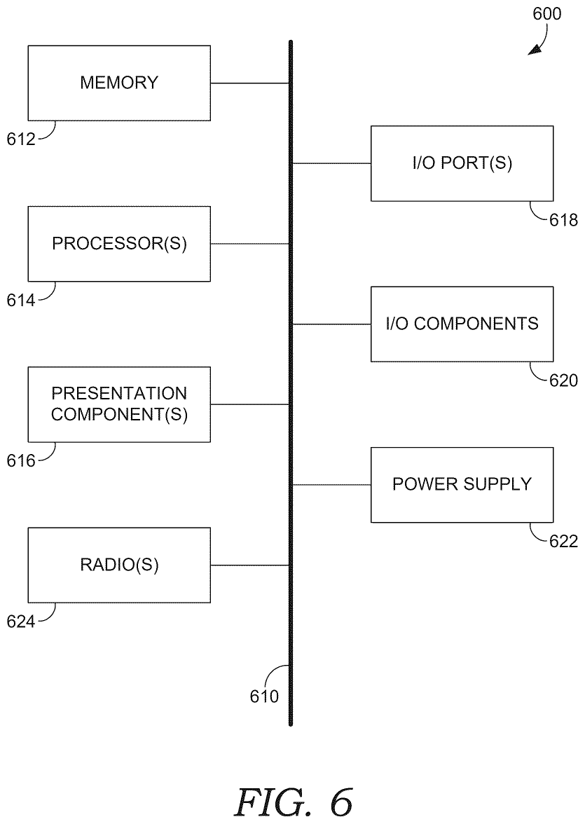

UE(s) 110 are in general forms of equipment and machines such as, but not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, UE 110 may include computing devices such as, but not limited to, handheld personal computing devices, cellular phones, smart phones, tablets, laptops, and similar consumer equipment, or stationary desktop computing devices, workstations, servers, and/or network infrastructure equipment. As such, the UE 110 may include both mobile UE and stationary UE. A UE 110 can include one or more processors and one or more non-transient computer-readable media for executing code to carry out the functions of the UE 110 described herein. The computer-readable media may include computer-readable instructions executable by the one or more processors. In some embodiments, the UE 110 and/or edge sever(s) 164 may be implemented using a computing device 600, as discussed below with respect to FIG. 6.

As shown in FIG. 1, the user plane function (UPF) 136 represents at least one function of the operator core network 106 that may extend into the core network edge 105. In some embodiments, the RAN 102 is coupled to the UPF 136 within the core network edge 105 by a communication link that includes an N3 user plane tunnel 108. For example, the N3 user plane tunnel 108 may connect a cell site router of the RAN 102 to an N3 interface of the UPF 136. The data store(s) 109, server(s) 156 and/or other elements of DN 107 may be coupled to the UPF 136 in the core network edge 105 by an N6 user plane tunnel 111. For example, the N6 user plane tunnel 111 may connect a network interface (e.g., a switch, router, and/or gateway) of the DN 107 to an N6 interface of the UPF 136. In some embodiments, the operator core network 106 may comprise a plurality of UPFs 136, such as a UPF at the operator core network 106 and a UPF at the core network edge 105. For example, a UPF at the core network edge 105 may be used for local breakout and/or low-latency types of applications via an N9 interface between the distinct UPFs.

When a UE 110 enters the coverage area, it may connect with the RAN(s) 102, authenticate to the operator core network 106, and gain access to services of the operator core network 106 based on a subscription policy associated with that UE 110. For example, in some embodiments, the UE 110 may comprise at least one application 112 that establishes one or more protocol data unit (PDU) sessions with the network and any associated services through the UPF 136. The network and associated services may comprise one or more applications associated with a network slice 115. For example, the network and associated services may comprise streaming content, two-way video/multimedia conferencing services, catalogs and/or access to other databases, messaging applications, real-time gaming applications, and/or other content or services. Using the baseline subscription policy associated with the UE 110, the PDU session between the application(s) 112 and the network may traverse a transport path through the operator core network 106 (e.g., through the UPF 136), the DN 107, Internet 150, and/or one or more other network elements to connect with the servers 156 hosting the services. As such, the latency, throughput, and/or reliability of that data path between the applications 112 and the services is a cumulative function of the latency, throughput, and/or reliability of each individual network element that forms a link in that path, as well as the resulting cumulative network device hop count.

As discussed herein, embodiments of this disclosure, among other things, establish a network slice blockchain integrity service (NSBIS) 130, which may be hosted as a network function of the operator core network 106 and may integrate the generation and activation of network slices with a blockchain ledger services 157. The blockchain ledger services may additionally or alternatively be hosted at an edge server 164, or at one or more servers 156 of a data network 107. The NSBIS 130 functions as a resource coordinator for instantiating blockchain ledger services 157 and coordinating the collection and storage of slice data associated with any number of slice transactions on a block of a blockchain ledger managed by the blockchain ledger services 157.

In embodiments, a distributed ledger, such as the blockchain ledger of the blockchain ledger services 157, may be utilized to secure the generation and activation of static or dynamic slices by recording transactions and data across multiple locations or nodes. A distributed ledger spreads data across a network of nodes each node maintaining a copy of the ledger. This allows the nodes to work together to validate transactions through consensus mechanisms. Transactions related to the distributed ledger are transparent and traceable to participants in the distributed ledger system allowing for consensus mechanisms such as Proof of Work or Proof of Stake algorithms to ensure that all nodes agree on the validity of transactions before they are added to the ledger. These consensus mechanisms may also allow for review of transactions after they have taken place. For example, if a dynamic or static slice is generated with falsified credentials or at an incorrect time, this transaction may be added to the blockchain ledger and the incorrect nature of the transaction may be detected by the consensus mechanism. This would allow for the detection of falsely or incorrectly generated/activated slices even after the slices were incorrectly generated or activated. Additionally, given the distributed nature, security, and consensus mechanisms, transactions that are recorded to a blockchain are not easily modified or deleted. This allows for the creation of a permanent and tamper-proof record.

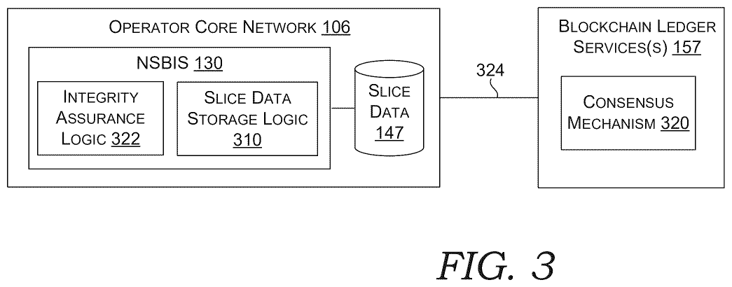

A blockchain ledger service 157 may comprise a set of applications and network functions hosted by one or more edge servers 164 at locations on the core network edge 105 within a close proximity (e.g., based on network device hops or other metric) to the RAN(s) 102 providing service to the UE 110 through the network slice 115. As described in greater detail with respect to FIG. 3, in some embodiments, the blockchain ledger service 157 may comprise applications that allow for the storage of slice data associated with any number of slice transactions. The blockchain ledger service 157 may additionally or alternatively be hosted by one or more servers 156 of a data network 107. Moreover, in some embodiments, the NSBIS 130 may control or communicate with the blockchain ledger service 157 in order to facilitate the storage of slice data in a secure and immutable nature on a block of a blockchain ledger of the blockchain ledger service 157.

In some embodiments, the NSBIS 130 generates and maintains a database of slice data 147 comprising information related to slice transactions such as slice identifiers, authorized user identifiers, time identifiers, geographic identifiers and any number of slice parameters such as bandwidth, latency, capacity of users available, or security parameters associated with a slice. For example, the NSBIS may compile or transmit slice data to an edge service such as edge server 164 or a server 156 of a data network 107 where the blockchain ledger services are held and organized. In embodiments, the slice data 147 maintained by the NSBIS 130 may comprise a set of base slice data that may be associated with any number of valid slice transactions such as a set of authorized user identifiers, or a set of valid time or geographic identifiers. In embodiments, the slice data 147 may comprise ranges of valid slice parameters such as a range of bandwidth that is valid for the generation of a new slice or a range of latency or set of security parameters which are valid for the generation or activation of a network slice. The NSBIS 130 may also store or manage slice data 147 that is generated at the time a network slice is requested, being generated, activated, requested to be activated, or accessed. As such, the slice data 147 may comprise sets of slice data associated with valid slices to be created and may also comprise slice data that is generated when a slice is requested to be generated or requested to be accessed.

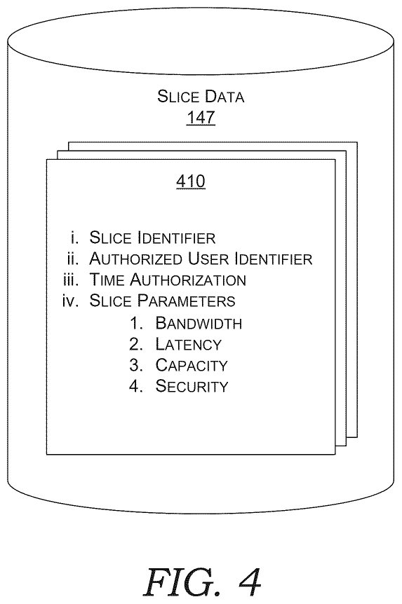

As an example, in some embodiments the NSBIS 130 may include slice data storage logic 310, as illustrated in FIG. 3. The slice data storage logic 310 may translate the slice data into a format that may be stored on a block of a blockchain ledger managed by the blockchain ledger service. The slice data storage logic 310 may also comprise logic related to the generation or activation of a slice once the relevant slice data has been stored to a blockchain ledger of the blockchain ledger service 157. As an example, as illustrated in FIG. 4, the slice data 147 may include a slice identifier, authorized user identifier, time identifier, geographic identifier, or slice parameters and may be stored in association with the slice identifier in a block of the block chain. In embodiments, the slice parameters may include the bandwidth, latency, the capacity of users available, security parameters, or any number of parameters that identify the unique nature of the slice.

In some embodiments, based on a physical address (or other location data) of a UE 110, the NSBIS 130 may determine which RAN(s) 102 are nearby and produce a coverage area 103 that covers the location of the UE 110, and may determine which edge server(s) 164 are in close proximity to those RAN(s) 102. The notion of proximity with respect to the proximity of edge server(s) 164 and the RAN(s) 102 may refer to a network device hop count, a physical distance, and/or other characteristic(s) of the network infrastructure that may affect the amount of time it takes for network traffic to traverse the path from one to the other.

The NSBIS 130 may instruct the RAN(s) 102 to send a message to those UE 110 identified as being located within the geolocation region 104, providing an alert (e.g., a Short Message/Messaging Service (SMS) message, application notification, pop-up message, or similar notification) on the UE 110 informing the user of their option to join a newly generated or activated slice to obtain services provided by the network slice. If the user accepts the offer, the user may input into the UE 110 their acceptance of the option. An indication of the acceptance may then be communicated in a message from the UE 110 to the NSBIS 130. The NSBIS may use this information to determine the capacity of users available based on the information stored in association with the blockchain ledger service 157. If the capacity has been met, the service may be denied. In embodiments, the NSBIS may determine if a UE may join the network slice based on a set of authorized user identifiers stored in association with the slice on the blockchain ledger. In response to determining capacity or proper identifiers, the NSBIS 130 may coordinate with the network slice selection function (NSSF) 141 and/or other network functions to allocate and/or instantiate a network slice 115 to carry network traffic between the UE 110 and the service provided by the network slice.

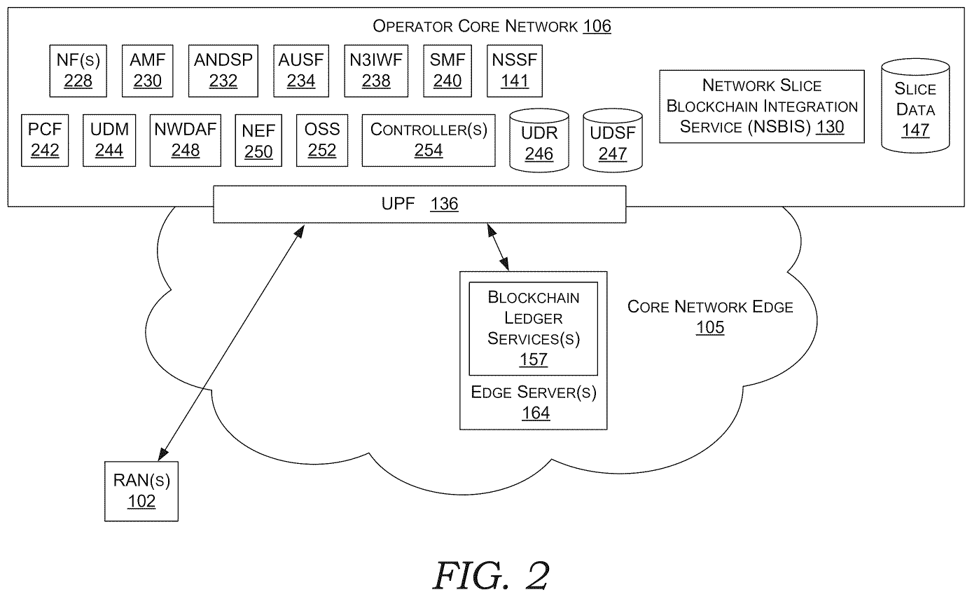

Referring now to FIG. 2, in some implementations, the operator core network 106 may comprise modules, also referred to as network functions (NFs), implemented by one or more processors and generally represented in FIG. 2 as NF(s) 228. Individual network functions that are distinctly illustrated in FIG. 1 may include, but are not limited to, one or more of a core access and mobility management function (AMF) 230, an access network discovery and selection policy (ANDSP) 232, an authentication server function (AUSF) 234, the user plane function (UPF) 136, non-3GPP interworking function (N3IWF) 238, a session management function (SMF) 240, the network slice selection function (NSSF) 141, a policy control function (PCF) 242, unified data management (UDM) 244, a unified data repository (UDR) 246, an unstructured data storage function (UDSF) 247, a network data analytics function (NWDAF) 248, a network exposure function (NEF) 250, and an operations support system (OSS) 252. Implementation of these NFs of the operator core network 106 may be executed by one or more controllers 254 on which these network functions are orchestrated or otherwise configured to execute utilizing processors and memory of the one or more controllers 254. The NFs and/or one or more elements of the blockchain ledger service 157 may be implemented as physical and/or virtual network functions, container network functions, and/or cloud-native network functions, such as is described with respect to FIG. 6. Within the context of network slice(s) 115 created by the operator core network 106, the operator core network 106 may orchestrate individual dedicated instances of one or more of the network functions described herein to establish and support operation of a network slice 115.

Notably, the nomenclature used herein is used primarily with respect to the 3GPP 5G architecture. In other aspects, one or more of the network functions of the operator core network 106 may take different forms, including consolidated or distributed forms that perform the same general operations. For example, the AMF 230 in the 3GPP 5G architecture is configured for various functions relating to security and access management and authorization, including registration management, connection management, paging, and mobility management. In other forms, such as a 4G architecture, the AMF 230 of FIG. 2 may take the form of a mobility management entity (MME). The operator core network 106 may be generally said to authorize rights to and facilitate access to an application server/service, such as provided by application function(s) requested by one or more UEs, such as UE 110. In some embodiments, the NSSF 141 works in conjunction with the AMF 230 to establish network slice instances of network slice(s) 115, such as is described herein. That is, based on determining that the slice data associated with a network slice transaction has been stored on a blockchain ledger of the blockchain ledger service 157, a request is triggered by the NSBIS 130 requesting the NSSF 141, possibly in conjunction with the AMF 230, to establish and/or allocate a network slice 115. As such, the NSBIS may coordinate the storage of slice data in association with the blockchain ledger service, determine that said slice data has been stored, and then trigger the generation or activation of a slice utilizing the NSSF 141.

Returning to FIG. 2, The AMF 230 facilitates mobility management, registration management, and connection management for 3GPP devices, such as a UE 110. ANDSP 232 facilitates mobility management, registration management, and connection management for non-3GPP devices (e.g., devices that connect via the N3IWF 238). AUSF 234 may receive authentication requests from the AMF 230 and interact with UDM 244, for example, for SIM authentication and/or to authenticate a UE 110 based on a device identification (ID). N3IWF 238 provides a secure gateway for non-3GPP network access, which may be used for providing connections for UE 110 access to the operator core network 106 over a non-3GPP access network (e.g., via a data link established between a customer premise gateway and the N3IWF 238).

SMF module 240 facilitates initial creation of protocol data unit (PDU) sessions with UE 110 using session establishment procedures. The PCF 242 maintains and applies policy control decisions and subscription information. Additionally, in some aspects, the PCF 242 maintains quality of service (QoS) policy rules. For example, the QoS rules stored in a unified data repository (UDR) 246 can identify a set of access permissions, resource allocations, or any other QoS policy established by an operator. The Unstructured Data Storage Function (UDSF) 247 may store dynamic state data, which is structured and unstructured data related to network function of the operator core network 106. That is, the UDSF 247 may support storage and retrieval of structured and/or unstructured data by other network functions 228 of the operator core network 106, including information relating to access control and service and/or microservice subscriptions. In embodiments, the NSBIS may be in communication with the UDR and/or UDSF to determine slice data or a set of predetermined slice parameters in association with the operator core network 106. This data may be stored separately as slice data 147, or slice data 147 may represent the relevant information utilized by the NSBIS as it is stored in association with the operator core network 106.

In some embodiments, the PCF 242 maintains subscription information indicating one or more services and/or microservices subscribed to by each UE 110. In some embodiments, a PCF 242 instance may maintain subscription information pertaining to UE 110 authorized to access services from within a network slice 115, such as the blockchain ledger service 157 instantiated on edge server(s) 164. The UDM 244 manages network user data including, but not limited to, data storage management, subscription management, policy control, and operator core network 106 exposure. NWDAF 248 collects data (for example, from UE; other network functions; application functions; and operations, administration, and maintenance (OAM) systems) that can be used for network data analytics. The OSS 252 is responsible for the management and orchestration of one or more elements of the operator core network 106 and the various physical, virtual network functions, container network functions, controllers, computer nodes, and other elements that implement the operator core network 106.

Some aspects of network environment 100 and/or operator core network 106 include the UDR 246 storing information relating to control, generation, activation, and access to network slices. The UDR 246 may be configured to store information relating to such slice transactions and may be accessible by multiple different network functions (NFs) 228 in order to perform desirable functions. For example, the UDR 246 may be accessed by the AMF 230 in order to determine subscriber information pertaining to the UE 110 (e.g., which network slices the UE 110 is subscribed to use), accessed by a PCF 242 to obtain policy-related data, and/or accessed by NEF 250 to obtain data that is permitted for exposure to third-party applications (such as applications 112 executed by UE 110, for example). The NSBIS may also access the UDR to determine slice data to be stored in association with the blockchain ledger services. Other functions of the NEF 250 include monitoring of UE-related events and posting information about those events for use by external entities, providing an interface for provisioning UEs 110 (e.g., via PCF 242), and reporting provisioning events to the UDR 246. Although depicted as a unified data management module, UDR 246 can be implemented as a plurality of network function specific data management modules. As mentioned above, in the context of a network slice 115, the operator core network 106 may orchestrate individual instances of each of these network functions and other such network functions described herein that are dedicated to the network slice 115.

The UPF 136 is generally configured to facilitate user plane operation relating to packet routing and forwarding, interconnection to a data network (e.g., DN 107), policy enforcement, and data buffering, among other operations. Using network slicing (e.g., based on 5G software-defined networking managed by the 5G network slice selection function (NSSF) 141), the UPF 136 may establish a dedicated slice network function for one or more data channels between various network functions and other entities that act as, in essence, a distinct network (for example, establishing its own QoS, provisioning, and/or security) within the same physical network architecture of network environment 100. As explained herein, the NSSF 141, either alone or in conjunction with other network functions of the operator core network 106, may function as a slice coordination network function to control the operator core network 106 to orchestrate individual dedicated instances of one or more of the network functions described herein to generate, activate, or grant access to a network slice triggered by the NSBIS 130.

Referring now to FIG. 3, FIG. 3 illustrates an example embodiment of an NSBIS 130 and blockchain ledger service 157. As discussed herein, the blockchain ledger service 157 may be located at an edge server such as edge server 164 or may be located at a server such as server 156 of the data network 107. Additionally, as discussed herein and illustrated in FIG. 3, the NSBIS 130 may utilize slice data 147 associated with any form of slice transaction, for example creation, activation, or termination of a network slice, to generate an immutable record of the slice transactions on a blockchain of a blockchain ledger managed and/or hosted by the blockchain ledger service 157. In embodiments, the NSBIS 130 uses slice data storage logic 310 to manage and transmit sets of slice data through a connection 324 to the blockchain ledger service 157. The set of slice data transmitted through the utilization of the slice data storage logic 310 may be authenticated by a consensus mechanism 320 of the blockchain ledger service 157. Any type or number of consensus mechanisms such as Proof of Work or Proof of Stake algorithms may be utilized by the blockchain ledger service 157 as the consensus mechanism 320 to ensure that all nodes agree on the validity of transactions before they are added to a blockchain ledger. These consensus mechanisms may also allow for review of transactions after they have taken place. For example, if a dynamic or static slice is generated with falsified credentials or at an incorrect time, this transaction may be added to the blockchain ledger and incorrect nature of the transaction may be detected by the consensus mechanism 320. This would allow for the detection of falsely or incorrectly generated/activated slices even after the slices were incorrectly generated or activated. Additionally, given the distributed nature, security, and consensus mechanisms, transactions that are recorded to a blockchain are not easily modified or deleted. This allows for the creation of a permanent and tamper-proof record.

In embodiments, the integrity assurance logic 322 determines the incorrect nature of the transaction. For example, a subset of the slice data 147 may be a set of authorized slice data. In embodiments, this may be a set of authorized user identifiers a set of authorized times, authorized geographic regions, or authorized slice parameters. The set of authorized user identifiers may be any number of identifiers which indicates users that are authorized to create, activate, or terminate a network slice. In embodiments, the authorized user identifiers may indicate which actions are authorized by that authorized user identifier. For example, an authorized user identifier may indicate that an associated user may conduct any network slice transaction. An authorized user identifier may on the other hand indicate that an associated user may only conduct certain network slice transactions such as only being allowed to generate, activate, terminate, or any combination of the three. The authorized times may be pre-authorized time periods at which network slice transactions may take place. For example, the set of authorized slice data may list time periods at which certain slice transactions may take place. The authorized geographic regions may include geographic regions such as zip codes or other representations of geographic regions that are authorized for different forms of network slices and network slice transactions. The authorized slice parameters may include ranges of authorized parameters that network transactions are allowed to have. For example, there may be a maximum and/or minimum bandwidth, maximum and/or minimum latency, maximum and/or minimum capacity of users that network transactions must fall within in order to be valid. There may also be set security parameters that each network slice transaction must include or security thresholds that each transaction must meet in order to be a valid network slice transaction.

In additional or alternative embodiments, the integrity assurance logic 322 may also determine if or when slice data associate with a particular network slice transaction have been successfully stored to a blockchain of the blockchain ledger service 157. In embodiments, this includes that the network slice has been authenticated through the use of a consensus mechanism 320 and once it is determined that it is successfully stored, the blockchain ledger service 157 may transmit confirmation to the NSBIS 130 through, for example, connection 324. In embodiments, the NSBIS may query the blockchain ledger service 157 at predetermined, or specific times or intervals of time to determine what network slice transactions have been successfully added to the blockchain through connection 324. In response, the blockchain ledger service 157 may provide data to the NSBIS 130. The NSBIS 130 may utilize the integrity assurance logic 322 to determine which network slice transaction data has been properly stored on the blockchain ledger and based on this, determine that the network slice transaction data was successfully stored. In embodiments, the NSBIS 130 utilizes the slice data storage logic 310 to acknowledge or determine the blockchain ledger service 157 and integrity assurance logic 322 indicates that the slice data has been properly stored in a blockchain of the blockchain ledger service 157.

Upon determining that the relevant slice data for a network slice transaction has been properly stored on a blockchain of the blockchain ledger service 157, the NSBIS 130 may determine whether or not to authorize and allow the network slice transaction. For example, in one embodiment, the NSBIS 130 may determine that a network slice transaction is pending, or receive a request to initiation a network slice transaction. The relevant slice data 147 may be transmitted to the blockchain ledger service 157 for storage on a blockchain ledger. In embodiments, the integrity assurance logic 322 may only determine that the slice data for the associated network slice transaction has been properly stored on a blockchain of the blockchain ledger service 157. This determination may be utilized by the NSBIS and based on determining that the slice data has been stored, the NSBIS may initiate, permit, or cause to initiate the associated network slice transaction. In additional or alternative embodiments, the NSBIS may not initiate, permit, or cause to initiate the associated network slice transaction until it has been determined that the network slice transaction is a valid network slice transaction. As discussed above, the slice data storage logic 310 or integrity assurance logic 322 may compare the network slice data against a set of authorized slice data. If the network slice data matches or falls within the allowed ranges of the authorized slice data, the network slice transaction may be authorized. In said embodiment, the NSBIS 130 may, after the network slice data is authorized, initiate, permit, or cause to initiate the network slice transaction.

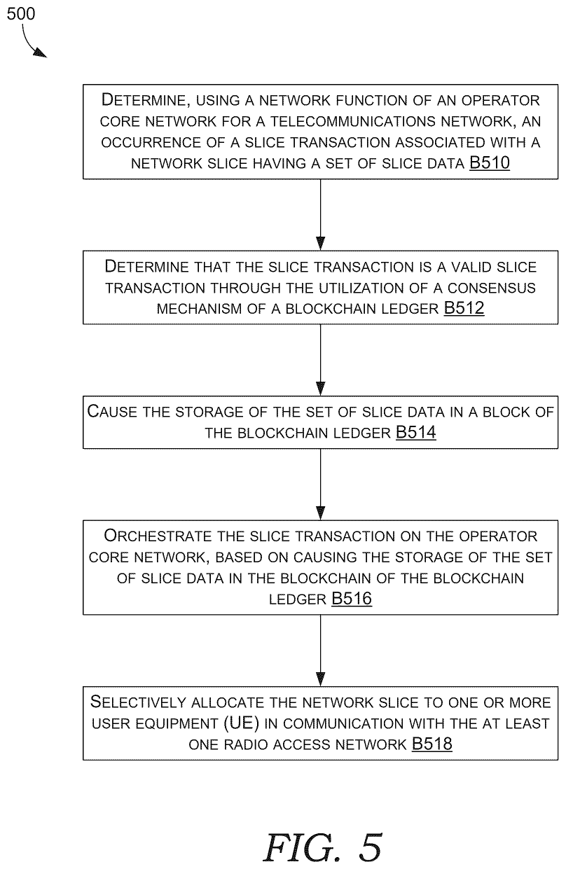

FIG. 5 is a flow cart illustrating a method 500 for a network slice blockchain integrity service, in accordance with some embodiments described herein. It should be understood that the features and elements described herein with respect to the method of FIG. 5 may be used in conjunction with, in combination with, or substituted for elements of any other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa. In some embodiments, elements of method 500 are implemented utilizing one or more processing units, such as the controller of an operator core network, an edge server, a RAN, a UE, and/or other processing units, as disclosed in any of the embodiments herein. In some embodiments, the method 500 may be implemented by components of a network environment 100, such as illustrated by FIG. 1, such as but not limited to, the NSBIS 130 (e.g., by one or more operations of the NSBIS 130) and/or blockchain ledger services 157 (e.g., by one or more operations of the blockchain ledger services 157).

The method 500 at B510 includes determining, using a network function of an operator core network for a telecommunications network, an occurrence of at least one network slice transaction associated with a set of slice data. For example, it may be determined that a user is attempting to create a network slice with a set of network parameters. The user identifier along with slice data associated with that slice transaction may be collected and stored in association with the NSBIS 130. In embodiments, the slice transaction may be associated with any form of slice data for example, slice identifier, user identifier, time identifier, geographic identifier, bandwidth, latency, capacity of users, or security parameters.

The method 500 at B512 includes determining when the at least one slice transaction is valid slice transaction based at least on a consensus mechanism of at least one blockchain ledger. In embodiments, the slice data associated with the network slice transaction is transmitted to the blockchain ledger service 157 and during the process of being stored, or prior to storage on a blockchain of the blockchain ledger, it may be determined that the slice transaction is a valid slice transaction. In embodiments, this may comprise utilizing integrity assurance logic 322 to compare the slice data associated with the network slice transaction against authorized parameters, or may require ensuring that the slice data is accurate in comparison to slice data already stored on the blockchain. The consensus mechanism such as consensus mechanism 320 ensures that the slice data for the network slice transaction is accurately stored on the blockchain and is validated across any number of nodes. In order to determine validity, it is not required that the consensus mechanism 320 compare the slice data against any sets of authorized slice data. The consensus mechanism 320 may utilize the data currently stored on the blockchain to determine that the blockchain to which it is being stored is the appropriate blockchain. This may constitute ensuring that the slice identifier matches the slice identifiers of the previous blocks. In said embodiment, the consensus mechanism 320 ensures that the new block being added is for the correct slice. The remaining slice data may later be determined, for example by the integrity assurance logic 322, to be fraudulent, accidental or a faulty network slice transaction. In such instances, the immutable record stored on the blockchain may indicate the time, geographic region, or user identifier which was associated with the faulty network slice transaction. This information may be used to determine a user that initiated the faulty network slice transaction, or a time or region prone to faulty network transactions. As such, the slice data stored to the blockchain does not need to be valid in the sense of indicating that it is a correct slice transaction. But is valid in the sense that the immutable record may be used to track all transactions and the data associated with each network slice transaction. That being said, as discussed above, in embodiments, slice transactions may be rejected based on determining that they are faulty prior to the storage of the data on the blockchain. In said examples, the consensus mechanism 320 and integrity assurance logic 322 may determine that the network slice is invalid due to faulty or incorrect slice data and transmit this invalidity to the NSBIS 130 which may deny the network slice transaction.

The method 500 at B514 includes recording the at least one slice transaction to the set of slice data and causing the storage of the set of slice data in a block of the at least one blockchain ledger. For example, if it is determined that the network transaction is valid, either as a correct and not faulty transaction, or just as a correct set of information to be stored to the correct blockchain, the set of slice data may be store to the appropriate blockchain.

The method 500 at B516 includes applying the at least one slice transaction to configure a network slice, wherein the network slice is configured based at least on the set of slice data recorded to the at least one blockchain ledger. In embodiments, the application of the at least one slice transaction is triggered in response to the storage of the set of slice data in the blockchain of the blockchain ledger. In embodiments, the network slice transaction is not applied until it is confirmed that the slice data associated with the network slice transaction has been stored to a blockchain ledger of the blockchain ledger service. If it cannot be determined or confirmed that the slice data has been properly stored, the NSBIS 130 may deny the network slice transaction. In additional or alternative embodiments, the network slice transaction may be orchestrated, but flagged if it cannot be determined that the associated slice data has been properly stored.

The method 500 at B518 includes selectively configure one or more operations of the operator core network based at least on the at least one slice transaction, wherein the network slice is allocated to one or more user equipment (UE) in communication with the at least one radio access network. The NSBIS 130 may utilize the slice data to determine what user equipment to allocate the network slice to. In embodiments, the network slice transaction generates a network slice that is available to a set number of a set type of user equipment. In said embodiments, the user equipment may choose to join the allocated network slice. Additionally or alternatively, if it is determined that the network slice transaction is invalid or is faulty, the network slice may be terminated by the NSBIS.

Referring to FIG. 6, a diagram is depicted of an exemplary computing environment suitable for use in implementations of the present disclosure. In particular, the exemplary computer environment is shown and designated generally as computing device 600. Computing device 600 is but one example of a suitable computing environment and is not intended to suggest any limitation as to the scope of use or functionality of the embodiments described herein, and nor should computing device 600 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 6, computing device 600 includes bus 610 that directly or indirectly couples the following devices: memory 612, one or more processors 614, one or more presentation components 616, input/output (I/O) ports 618, I/O components 620, power supply 622, and radio 624. Bus 610 represents what may be one or more buses (such as an address bus, data bus, or combination thereof). The devices of FIG. 6 are shown with lines for the sake of clarity. However, it should be understood that the functions performed by one or more components of the computing device 600 may be combined or distributed amongst the various components. For example, a presentation component such as a display device may be one of I/O components 620. In some embodiments, one or more functions of a UE 110, an NSBIS 130 and/or blockchain ledger service discussed herein may be executed at least in part by computing device 600. The processors 614 of computing device 600 may include a memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. For example, applications NSBIS 130 and/or blockchain ledger service 157 may be stored in a memory comprising such computer-readable media. Computer-readable media can be any available media that can be accessed by computing device 600 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient RAM, ROM, EEPROM, flash memory or other memory technology, CD-ROM, digital versatile disks (DVDs) or other optical disk storage, magnetic cassettes, magnetic tape, magnetic disk storage or other magnetic storage devices. Computer storage media and computer-readable media do not comprise a propagated data signal or signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or non-volatile memory. Memory 612 may be removable, non-removable, or a combination thereof. Exemplary memory includes solid-state memory, hard drives, optical-disc drives, etc. Computing device 600 includes one or more processors 614 that read data from various entities such as bus 610, memory 612, or I/O components 620. In some embodiments, one or more of the functions described herein of the NSBIS 130, blockchain ledger service 157 and/or UE 110 are implemented by one or more of the processors 614. One or more presentation components 616 presents data indications to a person or other device. Exemplary one or more presentation components 616 include a display device, speaker, printing component, vibrating component, etc. I/O ports 618 allow computing device 600 to be logically coupled to other devices including I/O components 620, some of which may be built into computing device 600. Illustrative I/O components 620 include a microphone, joystick, game pad, satellite dish, scanner, printer, wireless device, etc.

Radio(s) 624 represents a radio that may facilitate communication with a wireless telecommunications network. For example, radio(s) 624 may be used to establish communications with components of the RAN 102, operator core network 106, and/or core network edge 105. A radio module of a UE 110 may be implemented at least in part by the radio(s) 624. Illustrative wireless telecommunications technologies include CDMA, GPRS, TDMA, GSM, and the like. Radio(s) 624 may additionally or alternatively facilitate other types of wireless communications including Wi-Fi, WiMAX, LTE, and/or other VoIP communications. In some embodiments, radio(s) 624 may support multimodal connections that include a combination of 3GPP radio technologies (e.g., 4G, 5G, and/or 6G) and/or non-3GPP radio technologies. As can be appreciated, in various embodiments, radio(s) 624 can be configured to support multiple technologies and/or multiple radios can be utilized to support multiple technologies. In some embodiments, the radio(s) 624 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

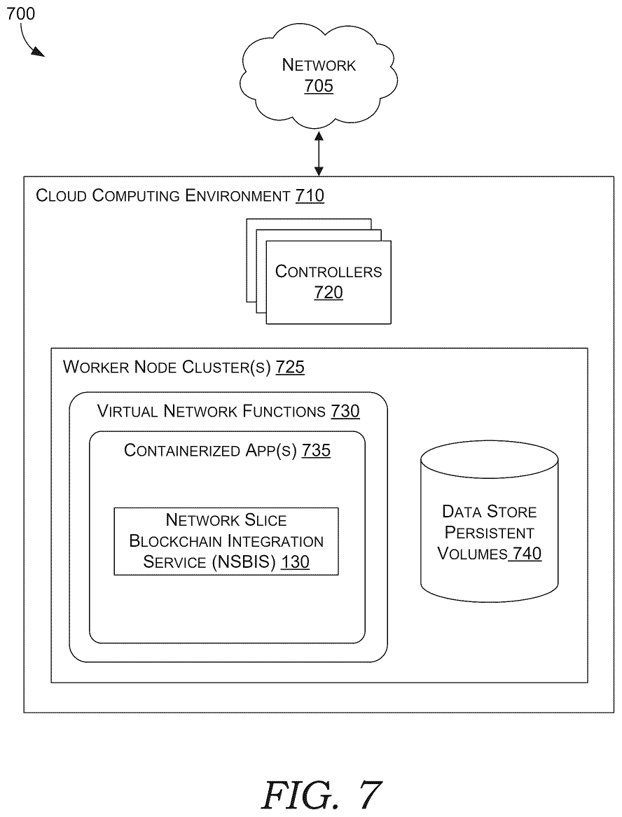

Referring to FIG. 7, a diagram is depicted generally at 700 of an exemplary cloud computing environment 710 for implementing one or more aspects of an architecture for an NSBIS 130 and/or blockchain ledger service 157 by the systems and methods described herein. Cloud computing environment 710 is but one example of a suitable cloud computing environment and is not intended to suggest any limitation as to the scope of use or functionality of the embodiments presented herein. Neither should cloud computing environment 710 be interpreted as having any dependency or requirement relating to any one or combination of components illustrated. In some embodiments, the cloud computing environment 710 is coupled to a network 705 and executed within operator core network 106, the core network edge 105, NSBIS 130, or is otherwise coupled to the core network edge 105 or operator core network 106.

Cloud computing environment 710 includes one or more controllers 720 comprising one or more processors and memory. The controllers 720 may comprise servers of a data center. In some embodiments, the controllers 720 are programmed to execute code to implement at least one or more aspects of the NSBIS 130 and/or blockchain ledger service 157. For example, in one embodiment an NSBIS 130 and/or blockchain ledger service 157 as discussed herein may be implemented as one or more virtual network functions (VNFs) 730 (which may include one or more container network functions (CNFs)) running on a worker node cluster 725 established by the controllers 720.

The cluster of worker nodes 725 may include one or more orchestrated Kubernetes (K8s) pods that realize one or more containerized applications 735. In other embodiments, another orchestration system may be used. For example, the cluster of worker nodes 725 may use lightweight Kubernetes (K3s) pods, Docker Swarm instances, and/or other orchestration tools. In some embodiments, one or more elements of the network environment 100 may be implemented by, or coupled to, the controllers 720 of the cloud computing environment 710 by operator core network 106 and/or core network edge 105. In some embodiments, one or more elements of the NSBIS 130 and/or blockchain ledger service 157 (such as slice data 147, for example) may be implemented at least in part using one or more data store persistent volumes 740 in the cloud computing environment 710. For example, in some embodiments, slice data 147 may be hosted by the one or more data store persistent volumes 740.

In various alternative embodiments, system and/or device elements, method steps, or example implementations described throughout this disclosure (such as the UE, access networks, core network edge, operator core network, network functions, NSBIS, blockchain ledger services, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize that elements, processes, or examples, said code stored on a non-transient hardware data storage device. Therefore, other embodiments of the present disclosure may include elements comprising program instructions resident on computer-readable media that when implemented by such computer systems enable them to implement the embodiments described herein. As used herein, the term “computer-readable media” refers to tangible memory storage devices having non-transient physical forms. Such non-transient physical forms may include computer memory devices, such as but not limited to: magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High Speed Integrated Circuit (VHSIC) Hardware Description Language (VHDL).

As used herein, the terms “network function,” “unit,” “server,” “node,” and “module” are used to describe computer processing components and/or one or more computer-executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for network slice blockchain integration, the system comprising:
one or more processors; and
one or more computer-readable media storing computer-usable instructions that, when executed by the one or more processors, cause the one or more processors to:
determine, using a network function of an operator core network for a telecommunications network, an occurrence of at least one network slice transaction associated with a set of slice data;
determine when the at least one slice transaction is a valid slice transaction based at least on a consensus mechanism of at least one blockchain ledger;
record the at least one slice transaction to the set of slice data and cause the storage of the set of slice data in a block of the at least one blockchain ledger;
apply the at least one slice transaction to configure a network slice, wherein the network slice is configured based at least on the set of slice data recorded to the at least one blockchain ledger; and
selectively configure one or more operations of the operator core network based at least on the at least one slice transaction, wherein the network slice is allocated to one or more user equipment (UE) in communication with the at least one radio access network.

2. The system of claim 1, wherein the set of slice data comprises at least one of a slice identifier, a user identifier, a time identifier, or at least one slice parameter.

3. The system of claim 2, wherein the at least one slice parameter comprises at least one of a bandwidth, a latency, a capacity, or a security parameter.

4. The system of claim 1, further comprising:
determine that the slice transaction is a faulty slice transaction; and
terminate the network slice.

5. The system of claim 4, further comprising:
transmit a notification to the one or more UEs that the network slice has been terminated.

6. The system of claim 4, wherein the one or more processors determine that the network slice is faulty based at least on a comparison of the network slice data to a set of authorized network slice data.

7. The system of claim 1, wherein the block of the at least one blockchain ledger is a first block of a new blockchain.

8. A telecommunication network, the network comprising:
an operator core network;
at least one edge server coupled to a core network edge of the operator core network;
at least one radio access network coupled to the operator core network, wherein the at least one radio access network establishes one or more communication links between the operator core network and one or more user equipment (UE); and
at least one network function executed on one or more processors of the operator core network to perform one or more operations to:
determine, using a network function of an operator core network for a telecommunications network, an occurrence of at least one slice transaction associated with a set of slice data;
record the at least one slice transaction to the set of slice data and cause the storage of the set of slice data in a block of at least one blockchain ledger on the at least one edge server;
apply the slice transaction to configure a network slice, wherein the network slice is configured based at least on the set of slice data recorded to the at least one blockchain ledger; and
selectively configure one or more operations of the operator core network based at least on the at least one slice transaction, wherein the network slice is allocated to the one or more user equipment (UE) in communication with the at least one radio access network.

9. The network of claim 8, wherein the storage of the set of slice data in the block of the at least one blockchain ledger comprises generation of an additional block of a pre-existing blockchain.

10. The network of claim 8, wherein the set of slice data comprises at least one of a slice identifier, a user identifier, a time identifier, or at least one slice parameter.

11. The network of claim 10, wherein the at least one slice parameter comprises at least one of a bandwidth, a latency, a capacity, or a security parameter.

12. The network of claim 8, further comprising:
determine that the slice transaction is a faulty slice transaction; and
terminate the network slice.

13. The network of claim 12, further comprising:
transmit a notification to the one or more UEs that the network slice has been terminated.

14. The network of claim 8, wherein the block of the at least one blockchain ledger is a first block of a new blockchain.

15. A method comprising:
determining, using a network function of an operator core network for a telecommunications network, an occurrence of at least one network slice transaction associated with a set of slice data;
determining, by a set of nodes associated with a blockchain ledger, when the slice transaction is a valid slice transaction based at least on a consensus mechanism of at least one blockchain ledger;
based on determining that the slice transaction is valid, recording the at least one slice transaction to the set of slice data and causing the storage of the set of slice data in a block of a blockchain ledger;
applying the at least one slice transaction to configure a network slice, wherein the network slice is configured based at least on the set of slice data recorded to the at least one blockchain ledger; and
selectively configuring one or more operations of the operator core network based at least on the at least one slice transaction, wherein the network slice is allocated to one or more user equipment (UE) in communication with the at least one radio access network.

16. The method of claim 15, wherein the set of slice data comprises at least one of a slice identifier, a user identifier, a time identifier, or at least one slice parameter.

17. The method of claim 15, wherein the at least one slice parameter comprises at least one of a bandwidth, a latency, a capacity, or a security parameter.

18. The method of claim 15, further comprising:
determining that the slice transaction is a faulty slice transaction; and
terminating the network slice.

19. The method of claim 15, further comprising:
transmitting a notification to the one or more UEs that the network slice has been terminated.

20. The method of claim 15, wherein causing the storage of the set of slice data in a block of the blockchain ledger comprises generating an additional block of a pre-existing blockchain.
